(19) United States
(12) Patent Application Publication
(10) Pub. No.: US 2026/0336110 A1
(43) Pub. Date: Oct. 29, 2026

(54) ENHANCED ROBOTIC CONTROL INTERFACE FOR DISTRIBUTED ROBOTIC SYSTEMS

(71) Applicant: Optum, Inc., Minnetonka, MN (US)

(72) Inventors: Peter Nelson DAY, Gilbert, AZ (US); Michael L. MAHAR, Tempe, AZ (US); Khoa Thuong CHAU, Litchfield Park, AZ (US)

(21) Appl. No.: 19/429,790

(22) Filed: Dec. 22, 2025

Related U.S. Application Data
(60) Provisional application No. 63/794,005, filed on Apr. 24, 2025.

(51) Int. Cl. B25J 9/16; B25J 19/02

(52) U.S. Cl. CPC B25J 9/1661; B25J 9/1669; B25J 19/021

(57) ABSTRACT

Various embodiments of the present disclosure provide a robotic interface that improves the functionality of a computer in various aspects. The techniques comprise receiving, from a remote server, a current state of a host table, wherein the host table corresponds to a table identifier associated with a robotic system; storing the current state of the host table within a local memory as a local table; storing a control array for instructing the robotic system based on an data entry from the local table; providing an executable instruction to a component of the robotic system based on the control array; storing, based on an execution response from the component of the robotic system, the control array as an outgoing entry in an outgoing table separate from the local table; and providing, to the remote server, the outgoing table to initiate an update to the host table.

### BACKGROUND

In distributed robotic environments, such as logistic facilities with robotic systems positioned therein, efficient coordination between central management systems and robotic logistic systems is hindered by several technical challenges. For example, traditionally, the coordination between a central management system and component robotic systems is handled by multiple intermediary software layers that translate high-level information into low-level robotic control commands. The efficacy of these systems is limited by the computational overhead and potential points of failure introduced by complex software architectures.

### BRIEF DESCRIPTION OF THE DRAWINGS

FIG. 1 is a block diagram of an example architecture in accordance with some embodiments of the present disclosure.

FIG. 2 is a block diagram of an example predictive data analysis computing entity in accordance with some embodiments of the present disclosure.

FIG. 3 is a block diagram of an example client computing entity in accordance with some embodiments of the present disclosure.

FIG. 4 is an operational example of an automated robotic system in accordance with some embodiments of the present disclosure.

FIG. 5 is an operational example of a portion of an automated facility in accordance with some embodiments of the present disclosure.

FIG. 6 is a system diagram of a localized control technique for a robotic system in accordance with some embodiments of the present disclosure.

FIG. 7 is a message flow diagram of a localized control technique for a robotic system in accordance with some embodiments of the present disclosure.

FIG. 8 is a flowchart diagram of localized control process in accordance with some embodiments of the present disclosure.

### DETAILED DESCRIPTION

Various embodiments of the present disclosure provide improved robotic control interfaces that enhance the efficiency and reliability of robotic systems within various automated environments. To achieve this, some embodiments of the present disclosure provide an interface that directly connects a programmable logic controller (PLC) to a centralized management system, such as a remote server, eliminating the need for intermediary applications and simplifying the communication process within a complex robotic ecosystem. To overcome performance limitations associated with traditional robotic control systems, the PLC of the present disclosure implements a unique table-based communication protocol. This protocol enables the PLC to query a remote server using a specific table identifier, receive a current state of a host table, and efficiently update a local table within the PLC's local memory. By leveraging this approach, the system may rapidly synchronize task information between a remote server and a robotic system, reducing latency and improving overall responsiveness. In this manner, the PLC of the present disclosure may overcome limitations in traditional robotic control architectures by enabling direct, efficient communication between the PLC and a remote server. This, in turn, eliminates potential points of failure associated with multiple intermediary applications, resulting in a more stable and reliable robotic control system.

In addition, or alternatively, to address challenges related to task tracking and completion verification in complex robotic systems, the present disclosure introduces an outgoing table structure and synchronization technique that may asynchronously push updates to a remote server. The outgoing table structure allows the PLC to efficiently store and manage completed task information separately from ongoing tasks. By periodically transmitting the outgoing table to the remote server, the system ensures accurate and timely updates of task statuses, facilitating seamless coordination between multiple robotic systems within a larger automated facility.

In addition, or alternatively, the techniques of the present disclosure may enhance robotic task execution times, throughput, and overall operational efficiency by implementing an intelligent task prioritization mechanism within the PLC. To do so, the PLC may store a local version of a host table maintained by a remote server. By doing so, the PLC may leverage robotic feedback, from one or more robotic components directly connected to the PLC, to intelligently select entries, originally from a host table, based on a predicted execution speed, an order priority, and/or other factors, such as the current orientation of robotic components, the retrieval positions of objects, and/or the like. By optimizing task order, the system minimizes unnecessary movements in automated robot operations, such as picking and handling operations that may be dependent on the orientation of a robotic device.

Examples of technologically advantageous embodiments of the present disclosure comprise improved distribution of functionality within an automated facility that eliminates intermediary services to improve the throughput and overall operational efficiency within the facility, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

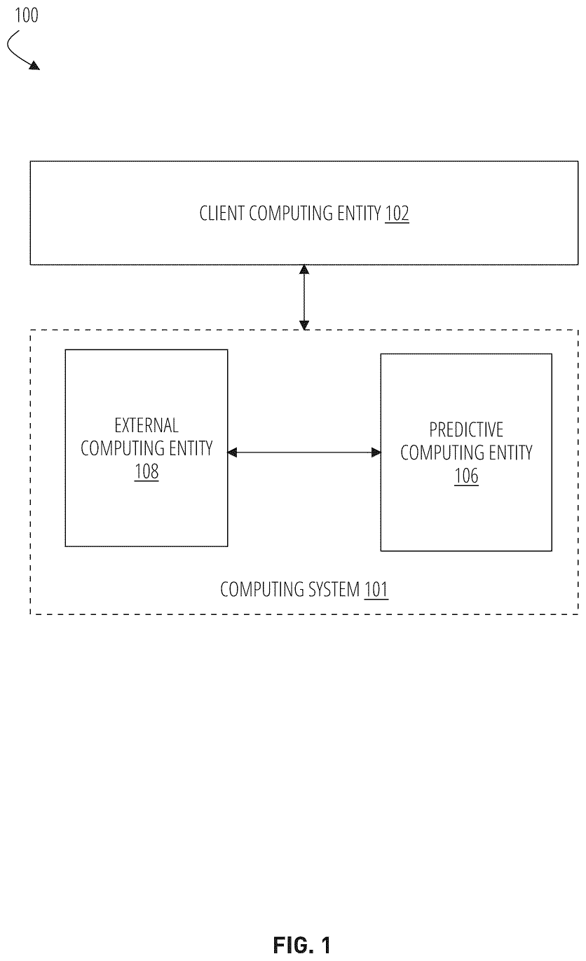

FIG. 1 is a block diagram of an example architecture 100 in accordance with some embodiments of the present disclosure. The architecture 100 comprises a computing system 101 configured to receive a request, such as an order for a fulfillment center, a data entry associated with the order, and/or the like, from client computing entities 102, process the request, and initiate robotic actions based on requests. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as host tables, local tables, and/or the like to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

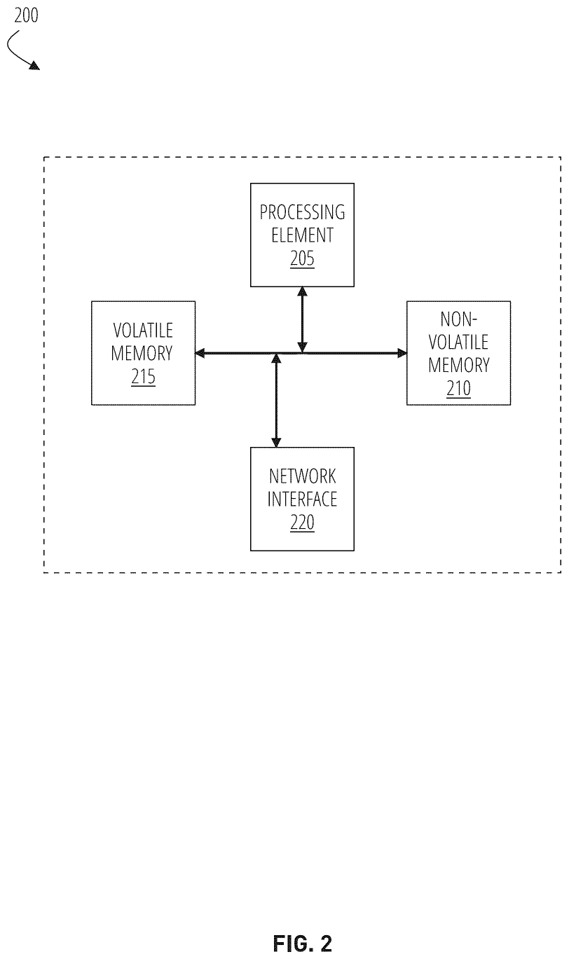

FIG. 2 is a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

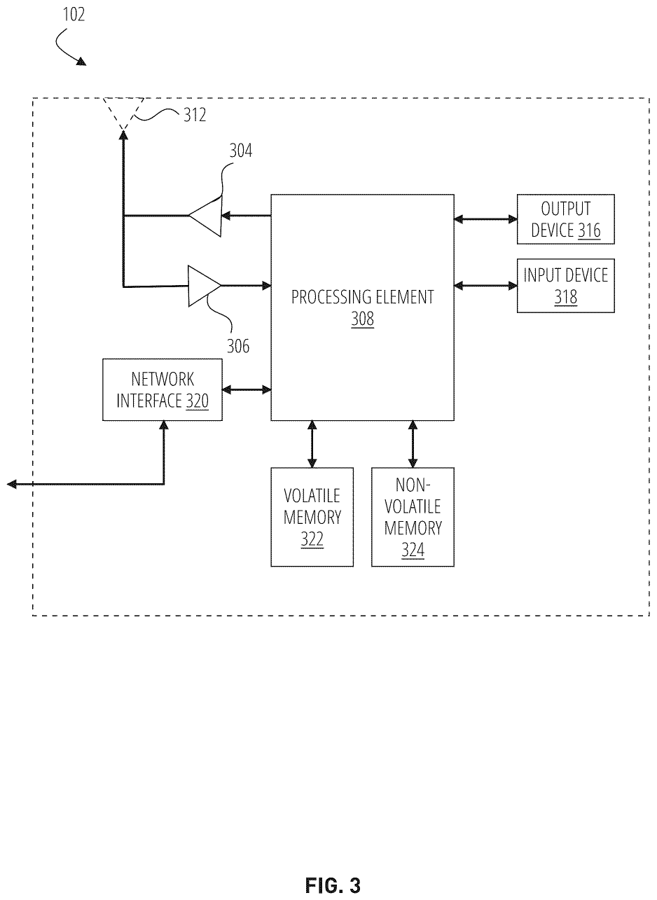

FIG. 3 is a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality. In particular, systems and methods are disclosed herein that implement robotic interfacing techniques that enable direct communication between control level components of a robotic system and a PLC. By doing so, the robotic interfacing techniques of the present disclosure enable improved (e.g., in terms of speed, reactivity, error avoidance) robotic operations within an operational facility of one or more of distributed robotic systems. This, in turn, may improve the functionality of a robotic systems with respect to various tasks, including pick and place operations, labeling operations, object tracking operations, among other automated tasks.

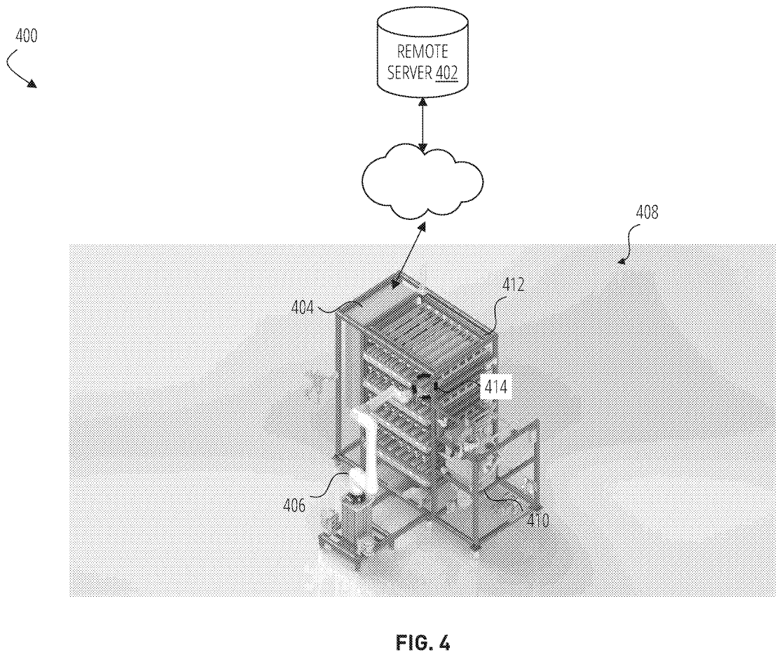

FIG. 4 is an operational example 400 of an automated robotic system in accordance with some embodiments of the present disclosure. As depicted, the robotic system 408 may comprise a set of robotic components. Generally, the set of robotic components may comprise one or more of a PLC 404, a labeler 410, a robotic arm 406, and/or a multi-channel storage platform 412.

In some embodiments, the robotic system 408 comprises a set of robotic components within a logistic facility that is configured to perform a logistics task, such as by moving objects from storage to a tote on a conveyance line. The robotic system 408 may comprise various interconnected components that may be controlled, by the PLC 404, in concert to automate the logistics task within a logistic facility. To do so, the robotic system 408, and/or the PLC 404 thereof, may receive logistics information from a remote server 402, identify the location of requested objects within a multi-channel storage platform 412, instruct the robotic arm 406 to retrieve the requested objects, and then instruct the robotic arm 406 to place the requested objects into totes positioned on the conveyance line. Throughout this process, the robotic system 408, and/or PLC 404 thereof, may employ one or more scanning and/or labeling operations to ensure accuracy and traceability of the requested objects.

In some embodiments, the PLC 404 is a programmable logic controller of the robotic system 408 and may comprise one or more processors, one or more memories, and/or one or more input/output interfaces, as described herein with reference to the computing system 101. The PLC 404, for example, may comprise a digital computer used for automation of industrial processes, such as control of machinery on factory assembly lines. In the context of the robotic system 408 described in this disclosure, the PLC 404 serves as the central control unit, managing the operations of all other components. To do so, the PLC 404 may be communicatively connected to the remote server 402 and/or up to each of the components of the robotic system 408.

The PLC 404 may comprise any type of computer with specialized software and hardware capabilities for a logistical task. By way of example, the PLC 404 may execute one or more automation logics, such as TwinCAT, Siemens Step 7, Rockwell RSLogix, and/or the like, which allows the PLC 404 to perform real-time control tasks and communicate with databases, such as those hosted by the remote server 402. In some examples, the PLC 404 may be equipped with both input and output interfaces that allow it to interact with various sensors and actuators within the robotic system 408. By way of example, the PLC 404 may be programmed to directly interface with an SQL database (e.g., via a TCP/IP communication channel), which is a departure from traditional PLC applications that often require intermediate layers of software. In addition, or alternatively, the PLC 404 may be directly or wirelessly connected to up to each of a set of robot components of the robotic system 408. For instance, the PLC 404 may communicate with one or more scanner(s) (e.g., conveyor scanner, object scanner, label scanner) via an Automation Device Specification (ADS) communication channel, the PLC 404 may communicate with the robotic arm 406 via an ethernet communication channel, and/or the like.

The PLC 404 may be designed to handle high-speed, deterministic, and reliable control of industrial processes. To do so, the PLC 404 may operate one or more cyclic, asynchronous, processes to continuously retrieve inputs, execute control logic, and update outputs. For example, as described herein, the PLC 404 may query the remote server at regular intervals (e.g., every 1000 milliseconds) to retrieve current state data. The PLC 404 may then process the retrieved information, translating high-level task data into specific instructions for each component of the robotic system 408, store updated data based on feedback from the robotic components, and push the updated data to the remote server 402 at regular intervals (e.g., every 1000 milliseconds). By doing so, the PLC 404 may act as the primary interface between a remote server 402 and/or the components of the robotic system 408.

In some embodiments, the robotic arm 406 is a robotic picking device, such as a mechanical arm that may be used to perform various tasks in automated environments. By way of example, the robotic arm 406 may comprise an articulated arm, a six-axis arm, a collaborative robot arm, a Selective Compliance Assembly Robot Arm (SCARA) arm, a cartesian arm, a cylindrical arm, spherical/polar arm, a parallel/delta arm, an anthropomorphic arm, a dual-arm, and/or the like. The robotic arm 406 may comprise one or more mechatronic systems that comprise one or more joints, links, and/or the like, up to each of which may be controlled by motors, actuators, and/or the like. In some examples, the motors, actuators, and/or the like may comprise servo motors, stepper motors, and/or the like, that allow for precise control of position and speed of one or more components of the robotic arm 406.

In some embodiments, the movements of the robotic arm 406 are coordinated by a control system, such as the PLC 404 of the robotic system 408. In some examples, the robotic arm 406 may be preprogrammed to pick an object from one or more channels of a multi-channel storage platform 412. The PLC 404 may initiate a picking operation from the robotic arm 406 by identifying a retrieval position 414 (e.g., a channel of the multi-channel storage platform 412) of the object to the robotic arm 406. For example, the robotic system 408 may be trained, configured, and/or the like, to position itself at a particular orientation in which an end effector is positioned at a channel of the multi-channel storage platform 412 corresponding to a retrieval position 414 of an object. In this way, the PLC 404 may provide specific coordinates (e.g., global coordinates, local coordinates of a local coordinate system defined relative to the robotic arm 406) to the robotic arm 406, and/or a PLC 404 (e.g., a channel identifier) corresponding to the specific coordinates.

In some embodiments, the robotic arm 406 is configured, trained, and/or the like to perform one or more pick and place tasks within the robotic system 408. The pick and place tasks may comprising a picking task in which the robotic arm 406 picks an object from a retrieval position 414 (e.g., a channel of the multi-channel storage platform 412), one or more scanning tasks in which the robotic arm 406 places the picked object within a field of view of one or more scanner(s), a labeling task in which the robotic arm 406 places the picked object within a range of a labeler 410, a placing task in which the robotic arm 406 places the picked object within a tote. Up to each of these tasks may correspond to a specific orientation of the robotic arm 406 and/or an action by an end effector of the robotic arm 406.

The robotic arm 406 may comprise one or more end effectors or tools that allow it to handle different types of objects. For example, the robotic arm 406 may comprise a vacuum gripper for handling lightweight, flat objects, and a mechanical gripper for heavier items, and/or the like. In addition, or alternatively, the robotic arm 406 may comprise one or more vision sensors (e.g., cameras), audio devices, presence scanners (e.g., photoelectric sensors), and/or the like. In some examples, the sensors may be integrated with and/or otherwise synchronized with the end effector of the robotic arm 406 to verify a successful pick and place task.

In some embodiments, the multi-channel storage platform 412 is a storage platform that stores one or more objects within a facility. The multi-channel storage platform 412 may comprise multiple indexed positions, or channels on which one or more different objects may be stored. The channels, for example, may comprise a shelf, portions of a shelf divided by a partition, and/or the like. In this regard, up to each channel within a multi-channel storage platform 412 may be defined by a vertical (e.g., level of shelf) and/or a horizontal (e.g., which of a set of partitioned areas on a shelf) index (e.g., coordinates in a local coordinate system). In some examples, up to each channel of the multi-channel storage platform 412 may store a particular object within a facility. In this way, a multi-channel storage platform 412 may comprise a specialized storage system designed to efficiently organize and store a variety of objects in a way that facilitates rapid retrieval within the robotic system 408.

In some examples, each channel of the multi-channel storage platform 412 may comprise one or more components configured to singulate and/or move a set of objects toward a front edge of the multi-channel storage platform 412. For example, a channel may comprise a set of partitions. The set of partitions may be spaced apart based on the physical dimensions of a particular object. For instance, the set of partitions may be separated by a distance that is within a tolerance of a width of the particular object. In this manner, the partitions may singulate the objects as they are stored between the partitions. In addition, or alternatively, the multi-channel storage platform 412 may comprise one or more conveyance assemblies, such as a belt conveyor, roller conveyor, chain conveyor, and/or the like. The conveyance assemblies may move objects within at least one of a set of channels toward a picking location of the multi-channel storage platform 412. The picking location, for example, may comprise a front position on up to each of a set of channels with multi-channel storage platform 412.

In some examples, the multi-channel storage platform 412 may correspond to a digital representation of the platform that may track the state of up to each of the set of channels within the multi-channel storage platform 412. For example, the digital representation may comprise a look up table that maps a particular object type to one or more channels within the multi-channel storage platform 412. For example, up to each channel may be assigned a unique identifier that corresponds to a specific location (e.g., a vertical and/or horizontal coordinate) of the multi-channel storage platform 412. The look up table may map a particular object to a unique channel identifier of the multi-channel storage platform 412 to translate a particular object to a physical pick location within a robotic system 408. In some examples, the digital representation may comprise a data structure within the PLC 404 and/or the remote server 402 that maps object identifiers to specific locations within the physical storage system. The digital representation may be implemented as a hash table, a binary search tree, and/or any other efficient data structure that allows for rapid lookup of object locations based on their identifiers.

In some examples, the multi-channel storage platform 412 may comprise one or more sensors positioned in up to each channel to detect the presence, absence, and/or position of objects within the channel. The sensors may comprise photoelectric sensors, weight-based sensors, and/or the like. In some examples, the sensors may provide feedback to a corresponding digital representation (e.g., incrementing or decrementing a count of objects within a channel, updating a status of a channel as empty, full) of the multi-channel storage platform 412, and/or the PLC 404 for use in directing the robotic arm 406 to a correct channel for picking an object.

In some embodiments, the robotic system 408 further comprises a labeler 410. The labeler 410 may comprise a manual, semi-automatic, and/or automatic labeling machine. For example, the labeler 410 may comprise a single sided and/or double sided label printer. In some examples, the label printer may comprise a tamp and fold label printer. The labeler 410, for example, may comprise a label feeder (e.g., a label wheel), a printing mechanism (e.g., a laser printer, a rotating drum or cylinder that uses static electricity to attract toner particles, such as powdered ink, based on an image projected by a laser, toner, fixed roller), and/or a folding mechanism. The labeler 410 may receive printing instructions (e.g., labeling control instructions) that reflect an image for printing to a blank label. The labeler 410 may project the image to the blank label, apply (e.g., by rolling, melting) toner to label in accordance with the projected image, and output a label to a guide platform. The guide platform may comprise a supporting structure, and the object label may be output with a print side facing the supporting structure. In some embodiments, the label printer comprises a fold mechanism that comprises a hinge connected to an actuator (e.g., pneumatic actuator). The hinge may connect a folding structure to the supporting structure. In operation, the folding mechanism may collapse the folding structure over the supporting structure to fold the first portion of the object label positioned on the folding structure over at least a portion of a second portion of the object label positioned on the supporting structure to create a double sided object label. In some examples, at least a portion of the second portion of the object label may be left exposed to allow adherence to an object.

In some examples, the robotic system 408 further comprises one or more scanner(s). The one or more scanner(s), for example, may comprise a conveyor scanner, an object scanner, a label scanner, and/or the like. Up to each of the scanners may comprise one or more different scanner(s) positioned at different locations relative to the robotic system 408 to provide sensor feedback with respect to a particular task.

The conveyor scanner, for example, may comprise a scanning device that is positioned adjacent to a portion of the conveyance assembly and configured to read identifying information from a tracking mechanism of a tote. The tracking mechanism, for example, may comprise a visual-based tracking mechanism (e.g., a one-or two-dimensional barcode), radio-based tracking mechanism (e.g., radio-frequency identification (RFID) tag), and/or the like. The conveyor scanner may comprise one or more of a vision scanner (e.g., a barcode scanner), radio scanner (e.g., RFID scanner), and/or the like.

The object scanner may comprise a scanning device that is positioned adjacent to one or more channels of the multi-channel storage platform 412 and is configured to read identifying information from indicia printed on an unlabeled object. The indicia, for example, may comprise a visual-based indicia (e.g., a one-or two-dimensional barcode), radio-based indicia (e.g., radio-frequency identification (RFID) tag), and/or the like. The object scanner may comprise one or more of a vision scanner (e.g., a barcode scanner), radio scanner (e.g., RFID scanner), and/or the like.

The label scanner may comprise a scanning device that is positioned adjacent to a labeler 410 and is configured to read identifying information from a label adhered to a labeled object. The label, for example, may comprise visual-based indicia (e.g., a one-or two-dimensional barcode), radio-based indicia (e.g., radio-frequency identification (RFID) tag), and/or the like. The label scanner may comprise one or more of a vision scanner (e.g., a barcode scanner), radio scanner (e.g., RFID scanner), and/or the like.

In some embodiments, the robotic system 408, and/or one or more components thereof, communicates with a remote server 402 to perform one or more automated tasks within a facility. The remote server 402, for example, may comprise an indirect control system, such as any one of the computing entities of the computing system 101, that is communicatively connected to a set of robotic systems within a facility and configured to distribute tasks across up to each of the set of robotic systems to optimize a throughput of the facility. The remote server 402, for example, may comprise a centralized management system for coordinating the operations of multiple robotic systems within a logistics environment. By way of example, the remote server 402 may act as a server in a client-server architecture, where it may act as the central point of control and the robotic systems may act as clients requesting tasks and reporting status.

The remote server 402 may comprise a local-and/or cloud-based digital environment that is configured to receive a set of logistic requests, such as single-or multi-object orders, and facilitate the fulfillment of the requests by transporting objects from one or more object-specific storage locations within the logistics facility to a single, end (e.g., a packaging) location. As described herein, the remote server 402 may facilitate the transport of the objects to an end location by generating an object entry for up to each object associated with an order and passing the object entry across one or more host tables corresponding to different logistical tasks within the facility. Each table, for example, may act as a task queue for a particular system within the facility. Upon updating a table with an object entry, the robotic system 408 may, as described herein, initiate a task with respect to an object entry, update the object entry to record feedback from the task, and then return the updated object entry to the remote server 402. The remote server 402 may receive the updated object entry, remove the object entry from the table, and then place the object entry in another table to initiate additional robot actions until up to each object referenced by an order is delivered to an end location.

In this manner, the remote server 402 may be used to manage and distribute logistics tasks across multiple robotic systems within a facility. In addition, or alternatively, the remote server 402 may maintain the overall state of the facility, including inventory levels, incoming orders, the status of up to each robotic system, and/or the like. Based on this information, the remote server 402 may determine which tasks should be assigned to which robotic system and may communicate these assignments through the asynchronous push and pull operations described herein. In this way, the remote server 402 may implement real-time monitoring of an entire logistics operation, predictive analytics for anticipating demand and optimizing inventory levels, and reporting tools for generating operational insights. In some examples, the remote server 402 may handle error detection and recovery, reassigning tasks if a particular robotic system encounters problems, and/or the like.

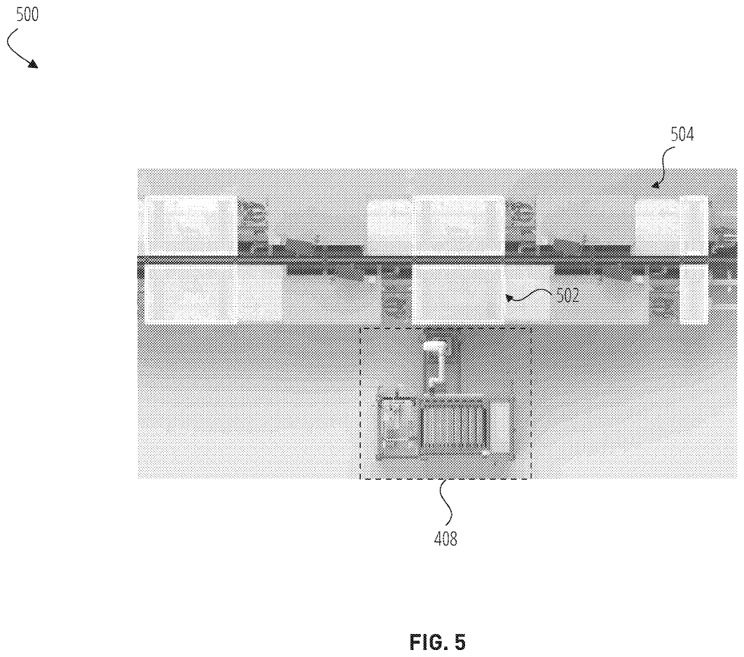

FIG. 5 is an operational example 500 of a portion of an automated facility in accordance with some embodiments of the present disclosure. As depicted, the robotic system 408 may be positioned on a portion of a conveyance line 504. For example, the robotic system 408 may be positioned within proximity to a loading platform 502 of the conveyor conveyance line 504. In some examples, the loading platform 502 may comprise one or more conveyor scanners, as described herein. In some examples, a set of conveyor scanners may be positioned at a set of various locations of a conveyance line 504. Up to each of the set of conveyor scanners may correspond to a relative and/or absolute position within the conveyance line 504. In some examples, this may enable a tracking of totes as they are moved in and out of conveyor scanner's field of view. For example, a conveyor scanner may provide (e.g., on a time interval, in response to detection stimuli or control instructions) detection messages to a robotic system 408 and/or remote server 402 that identify a tote a location of a detection event (e.g., a position of the conveyor scanner), and/or the like. By way of example, a conveyor scanner may be placed at a loading platform 502 of the robotic system 408 to provide a tote identifier for a tote loaded at the loading platform 502 for a particular picking and placing operation. As described herein, the PLC and/or remote server 402 may update an object entry with the tote identifier to track an object while it is moved across the conveyance line 504.

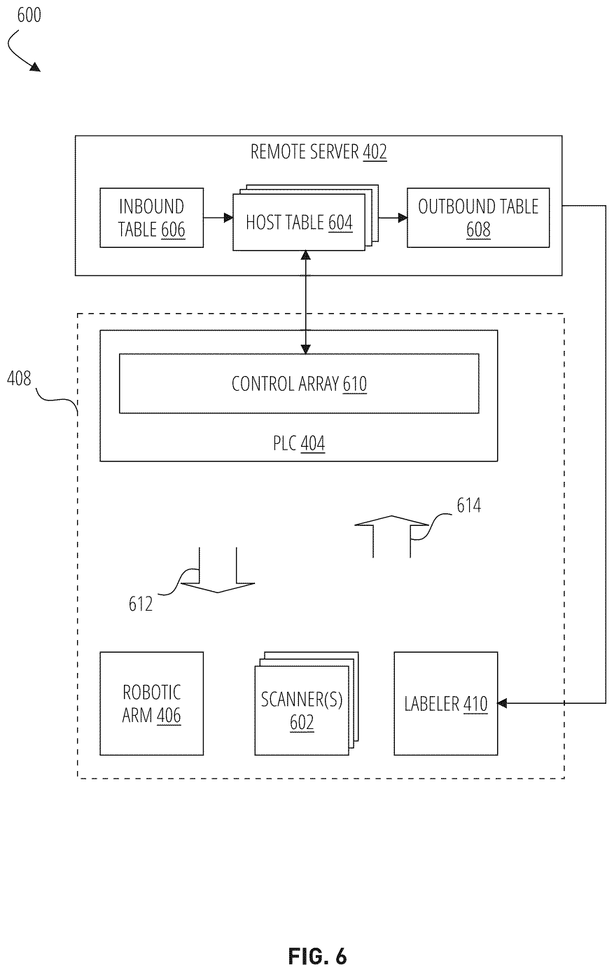

FIG. 6 is a system diagram 600 of a localized control process for a robotic system in accordance with some embodiments of the present disclosure. As depicted, the system diagram 600 may comprise a remote server 402 and at least one robotic system 408. The robotic system 408 may comprise a PLC 404, a robotic arm 406, one or more scanner(s) 602, a labeler 410, and/or the like. The one or more scanner(s) 602, for example, may comprise one or more conveyor scanners, object scanners, label scanners, as described herein. In some examples, the operations of the localized control process may be performed by any one of the components of the system diagram 600. In some examples, the PLC 404 may implement at least a portion of the localized control process. For example, a computer-implemented method for the localized control process may be performed by the PLC 404 of the robotic system 408 to improve the efficiency, reliability, and adaptability of the robotic system 408 by enabling task-level communication directly between the remote server 402, the PLC 404, and/or the other components of the robotic system 408. This direct communication may simplify the robotic process, reduce potential troubleshooting layers, and ensure more stable and efficient robotic operations within a logistics facility.

In some embodiments, the PLC 404 provides a query to the remote server 402. In some examples, the PLC 404 may provide the query to the remote server 402 at a first polling interval. In addition, or alternatively, the PLC 404 may provide the query to the remote server 402 in response to a detection of an object on the conveyance line, a completion of a data object within a control array 610, and/or the like. The query may comprise a table identifier corresponding to the robotic system 408 and/or one or more shared identifier. The table identifier, for example, may correspond to a host table 604 of a set of host tables managed by the remote server 402. For instance, the remote server 402 may store a set of host tables that respectively corresponds to a set of robotic systems within a logistics facility. The query may comprise a table identifier that is unique to the robotic system 408 of the set of robotic systems 408. In some examples, the query may comprise one or more shared identifiers and/or object identifiers associated with one or more data entries within a host table 604 of the remote server 402.

In some embodiments, the one or more shared identifiers and/or object identifiers are based on sensor data received by the PLC 404. For example, the PLC 404 may communicate with one or more conveyor scanners located at one or more positions within a logistics facility. A first conveyor scanner, for example, may correspond to a loading platform of the robotic system 408. A second conveyor scanner may correspond to a pre-loading location preceding the loading platform of the robotic system 408. In some examples, the PLC 404 may receive sensor data from up to each of the one or more conveyor scanners to track a location of one or more movable totes within the logistics facility. By way of example, the conveyor scanners may comprise radio frequency scanner, barcode scanners, and/or the like and may be configured to scan scanning indicia (e.g., a radio frequency identifier, a barcode) of the movable totes to receive one or more tote identifiers. In some examples, the one or more tote identifiers may correspond to one or more shared identifiers (e.g., within an order-tote lookup table). Using the presence data, the PLC 404 may detect a shared identifier located at the loading platform of the robotic system 408 and/or at the pre-loading location preceding the loading platform of the robotic system 408 and incorporate the shared identifiers within a query to ensure that the control array 610 is refreshed with data entries corresponding to totes within a proximity to the robotic system 408.

In some embodiments, the query comprises a polling request to the remote server 402 that requests a current state of a host table 604 corresponding to a particular robotic system 408. The query, for example, may comprise an asynchronous request that enables the robotic system 408 to retrieve its assigned tasks from the remote server 402 on a first polling interval. The first polling interval may comprise an interval of time (e.g., 1000 milliseconds) designed to trigger a query to the remote server 402. The first polling interval may be a predefined, static time interval. In addition, or alternatively, the first polling interval may be dynamically set based on one or more constraints of the robotic system 408. For example, the polling interval may be set based on an execution time (e.g., average, minimum, maximum) of a task by the robotic system 408. By way of example, the polling interval may be set to a time interval (e.g., 1000 milliseconds) that is less than a minimum task duration (e.g., 2 seconds) of the robotic system 408 to ensure a synchronization between the robotic system 408 and the remote server 402. In this manner, the first polling interval may provide a synchronization parameter between the robotic system 408 and the remote server 402, that may be modified to adjust a frequency with which the robotic system 408 synchronizes a local table 606 with a host table 604 of the remote server 402.

Generally, the query may comprise a structured request for information from a database and/or information system, such as the remote server 402. In some examples, the query may be transmitted in accordance with one or more network communication protocols. For example, at the lowest level, the query may be transmitted through a network protocol (e.g., TCP/IP) that handles the exchange of data between the robotic system 408 and the remote server 402. In some examples, the query may be structured according to another network protocol, such as HTTP or a custom protocol, that structures the query and/or a query response in a format that recognized by both the PLC 404 and the remote server 402. In some examples, the query may comprise query language, which may be structured according to another protocol, such as SQL for a relational database, or a custom query format designed for the host table 604, and/or the like.

In some examples, the query may be generated and provided by the PLC 404 of the robotic system 408 to retrieve at least a portion of the current state of the host table 604 from the remote server 402 that corresponds to the robotic system 408. To do so, the query may comprise a table identifier corresponding to the host table 604. In some examples, the query may request the entire host table 604. In addition, or alternatively, the query may request a portion of the current state of the host table 604. For example, the query may comprise one or more shared identifier (e.g., identifiers, such as an order id, shared by one or more entries within the host table 604), entry identifier (e.g., unique identifiers, such as an object identifier, that uniquely identifies an entry within the host table 604), and/or the like.

In some embodiments, the table identifier is a unique identifier for a host table 604. The table identifier, for example, may comprise a unique key, token, and/or the like that may reference a specific table within the remote server 402. The table identifier, for example, may comprise a table name, a hashed identifier, a universally unique identifier (UUID), and/or any other form of identification. By way of example, the table identifier may comprise primary key for the host table 604, ensuring that each table maintained by the remote server 402 may be uniquely identified.

The table identifier may be shared with a robotic system 408 (e.g., during configuration of the PLC 404) to establish a link between the robotic system 408 and a particular table (or set of tables) maintained by the remote server 402. Once shared, for example, the table identifier may be used as part of the protocol for querying and updating the host table 604 from the robotic system 408, allowing the robotic system 408 to specify a particular host table 604 in up to each communication between the robotic system 408 and the remote server 402. In this manner, a table identifier may ensure that each of a set of robotic systems interacts with a particular table maintained by the remote server 402.

In some embodiments, the PLC 404 receives, from the remote server 402, at least the portion of the current state of a host table 604. The host table 604, for example, may correspond to the table identifier associated with the robotic system 408. By way of example, at least the portion of the current state of the host table 604 may be received in response to the query to the remote server 402 with the table identifier that corresponds to the robotic system 408.

In some embodiments, the host table 604 is one of a set of host tables 604 respectively maintained by the remote server 402 for a set of robotic systems 408 within a logistics facility. The host table 604 may comprise a task scheduling data structure maintained by the remote server 402 for the robotic system 408. The host table 604 may comprise a database table and/or any other data storage mechanism (e.g., graph database) designed for efficient storage, retrieval, and/or modification of task-related information for a particular robotic system 408. In some examples, the host table 604 may serve as the primary means of communication between the remote server 402 and the robotic system 408.

In some embodiments, the host table 604 comprises a set of data entries that respectively correspond to tasks assigned, by the remote server 402, to a robotic system 408. In some examples, the host table 604 may be used as the primary mechanism for task assignment and status tracking. To do so, the remote server 402 may add new tasks, as data entries, to the host table 604 as orders are received. The robotic system 408 may query the host table 604 to synchronize a control array 610 to at least the portion of =a current state of the host table 604 and, by doing so, add a new tasks to its local task queue. As the robotic system 408 completes tasks, the robotic system 408 may provide feedback to the remote server 402 allowing the remote server 402 to track progress of tasks, remove tasks from host table 604, and assign new tasks as needed. In this manner, the host table 604 may serve as a real-time representation of the state of a set of tasks assigned to robotic system 408.

In some embodiments, the host table 604 is one of a set of data tables maintained by the remote server 402 for the robotic system 408. For example, the remote server 402 may maintain an inbound table 606, the host table 604, and/or an outbound table 608. The inbound table 606 and outbound table 608 may comprise temporary storage locations for uploading and/or offloading data entries to/from the host table 604.

For example, the inbound table 606 may comprise an entry point to the robotic system 408. During operation, the remote server 402 may receive one or more data entries from another table (e.g., an order server, an outbound table of another robotic system), endpoint, and/or the like, and add the data entries inbound table 606. The remote server 402 may validate (e.g., by verifying the presence of one or more data values within a data entry, detecting anomalous or defective values based on expected data schemas, pruning duplicative data entries) the data entries within the inbound table 606 and, if validated, the data entries may be removed from the inbound table 606 and added to the host table 604.

The outbound table 608 may comprise an exit point from the robotic system 408. During operation, the remote server 402 may monitor the host table 604 and add the data entries from the host table 604 to the outbound table 608 in response to one or more operational criteria. For example, the remote server 402 may be configured to monitor an object status identifier of each of the data entries within the host table 604 and add data entries to the outbound table 608 based on an updated status of the object status identifier. For example, in response to a detection of an updated object status identifier for a set of the data entries within the host table 604, the remote server 402 may remove the set of data entries from the host table 604 and add the set of data entries to the outgoing table 608. The remote server 402 may validate (e.g., by verifying the presence of one or more data values within a data entry, detecting anomalous or defective values based on expected data schemas, pruning duplicative data entries) the data entries within the outbound table 608 and, if validated, the data entries may be removed from the outbound table 608 and added to another table maintained by the remote server 402.

In some embodiments, the current state of the host table 604 comprises a set of data entries at a particular point in time. The host table 604, for example, may be updated continuously as new orders arrive, feedback is received from the robotic system 408, and/or the like. The current state details a current set of incomplete tasks assigned to the robotic system 408. It may be provided to the robotic system 408 in response to a query to synchronize the robotic system 408 with the remote server 402 by synchronizing the control array 610 to the current state of the host table 604.

In some embodiments, the PLC 404 stores at least the portion of the current state of the host table 604 within a local memory as the control array 610. The control array 610, for example, may comprise a local data structure maintained by the PLC 404 the stores at least a portion of the current state of the host table 604 in a modifiable and searchable format to improve the manipulation performance (e.g., in terms of speed, accuracy) of the data associated with the host table 604 as the PLC 404 controls one or more robotic components of the robotic system 408. The control array 610, for example, may be leveraged by the PLC 404 for instructing the robotic system 408 based on one more data entries from the host table 604.

In some embodiments, the control array comprises an array of data objects constructed from at least a portion of the host table 604. In some examples, a data object of the array of data objects comprises a set of data elements respectively corresponding to a set of data entries from the host table 604. The set of data entries, for example, may comprise a data entry and one or more related data entries from the host table 604 that are each associated with a shared identifier. The shared identifier, for example, may comprise an order identifier such that each data object may comprise a set of data elements respectively corresponding to a set of data entries within the host table 604 that belong to the same order.

In some examples, the PLC 404 may remove a preexisting control array and regenerate the control array 610 based on at least the portion of the current state of the host table 604. In this manner, the PLC 604 may replace a control array in response to each query.

In some embodiments, the control array 610 comprises a local version of the host table 604 that may be as current as the last received current state (and/or portion thereof) of the host table 604. The control array 610 may be stored in local memory (e.g., cache memory, random access memory (RAM)) of the PLC 404 to reduce the need for constant communication with the remote server 402. The control array 610, for example, may mirror the structure and/or content of a corresponding host table 604 at a particular point in time. In addition, or alternatively, the control array 610 may be implemented as another data structure (e.g., a struct array) based on the PLC's control algorithms.

In some embodiments, the control array 610 comprises a set of data objects that each group one or more data entries from the current state of the host table 604 according to shared identifiers. For example, a data object of the set of data objects may store a set of data elements respectively corresponding to a set of data entries comprising a shared identifier (e.g., order identifier). A data element, for example, may comprise a data entry from the remote server 402. By way of example, a data element may be implemented as an element nested within a data object of the control array 610 maintained in the local memory of the PLC 404. The data element may be stored in various data formats.

In some examples, the PLC 404 may generate the control array 610 by receiving a data entry from the host table 604, determining the shared identifier within the data entry, and then storing the data entry as a data element within the data object based on the shared identifier. For example, the PLC 404 may initialize a first data object based on a shared identifier corresponding to a first data entry within received portion of the host table 604. The PLC 404 may determine a shared identifier within a second data entry of the received portion of the host table 604. In response to determining a match between the shared identifier and the shared identifier of the initialized data object, the PLC 404 may store the second data entry as a second data element within the initialized data object. Otherwise, the PLC 404 may initialize a second data object based on the shared identifier of the second data entry. This process may be repeated for each data entry within a received portion of a host table 604 to generate a control array 610 comprising an array of data objects.

In some examples, a data entry may comprise one or more static elements (e.g., read-only) and/or one or more dynamic elements (e.g., read-write). The static elements may be updated by the remote server 402 and provided to the robotic system 408 in a readable format. The dynamic elements may be updated by the remote server 402 and provided to the PLC 404 in an editable format. In some examples, the static and/or dynamic elements may record tracking information for an object within a logistics facility. For example, the elements may comprise an entry row identifier (e.g., an order identifier), an object type identifier (e.g., an National Drug Code (NDC)), an origination identifier (e.g., GTINof an NDC), a label identifier (e.g., updated to latest label identifier), an object identifier, an object status identifier, an order status identifier, an object tote identifier, the total number of objects in an order, and/or the like.

The entry row identifier, for example, may comprise a unique identifier for an order received and processed by the remote server 402. For example, the entry row identifier may comprise a UUID, a GUID, a unique alphanumeric code, and/or any other identifying media that corresponds to an order. In some examples, the entry row identifier may serve as a shared identifier for grouping one or more items of the same order.

The object type identifier may comprise a unique identifier for an object type that is part of an order and stored within a particular robotic system 408. The object type identifier, for example, may correspond to a particular channel of a multi-channel storage platform 412 within the robotic system 408. In some examples, the object type may depend on the domain. For instance, in a pharmaceutical domain, the object type may comprise an NDC that identifies a particular type of drug.

The origination identifier may comprise a unique identifier for an origin from which a set of objects of a particular type may be supplied to the logistic warehouse. The origination identifier, for example, may correspond to a particular delivery of objects loaded to one or more channels of the multi-channel storage platform 412 within the robotic system 408. In some examples, the origination identifier may depend on the domain. For instance, in a pharmaceutical domain, the origination identifier may comprise a lGTIN that identifies a particular origin for a set of drugs. blah

The label identifier may comprise a unique identifier for a label adhered to an object. The object identifier may comprise a unique identifier of an indicia placed on the particular object. By way of example, the label identifier may comprise a barcode (e.g., a data matrix barcode) generated and/or printed to a label that is adhered to the particular object. In addition, or alternatively, the object identifier may comprise a barcode (e.g., a GS-1) that is printed, etched, and/or otherwise disposed on an outer package of the object. In some examples, the object identifier may comprise the origination identifier, a serial number, a lot number, an expiration date, and/or the like.

The object status identifier may comprise a categorical data element that may be modified to identify a particular stage of an object relative to the dispatch of an order. The object status identifier, for example, may comprise one or more of: not picked, picked, verified, labeled, label verified, placed, enroute, delivered, and/or the like. In some examples, the PLC 404 may update the object status identifier to record feedback from one or more components of the robotic system 408. In some examples, the remote server 402 may remove a data entry from a host table 604 in response to an object status identifier of placed or enroute.

The order status identifier may comprise a categorical data element that may be modified to identify a particular stage of an order that comprises an object. The order status identifier, for example, may comprise one or more of: received, in-process, processed, and/or the like. In some examples, the remote server 402 may aggregate data entries for up to each object in an order to update the order status. For example, in response to an object status identifier of “delivered” for up to each object in the order, the order status identifier may be modified to “processed” in each data entry representing an object of the order.

An object tote identifier may comprise a unique identifier for a tote assigned for delivering an object to an end location. The object tote identifier, for example, may comprise an identifier of a tracking mechanism of a tote, such as a barcode, RFID tag, and/or the like.

In some embodiments, the static and/or dynamic elements may depend on the domain and/or objects within the domain. For example, in a pharmaceutical logistics facility, the static and dynamic elements may record object and/or logistical information for a pharmaceutical object, such as drugs in a mail order pharmacy.

In some examples, the entry row identifier (e.g., an order identifier), the object type identifier, the origination identifier (e.g., GTIN), the order status identifier, the object tote identifier, the total number of objects in the order, and/or the like may comprise static elements within an data entry that may be determined and/or set by the remote server 402 and provided to the PLC 404 in a read-only format. In addition, or alternatively, the label identifier (e.g., updated to a latest label identifier), the object identifier, the status identifier, and/or the like may comprise dynamic elements within the data entry that may be set to null and/or to a preceding value and may be provided to the PLC 404 in an editable format. As described herein, the PLC 404 may modify the dynamic elements of a data entry to provide feedback to the remote server 402. In this manner, the data entry may serve as a bridge between the high-level task information provided by the remote server 402 and the low-level control instructions required by the robotic system 408. When the PLC receives at least the portion of the current state of the host table 604, the PLC 404 processes each row to create corresponding data elements in a locally stored control array 610. These data elements may then be used to execute executable instructions that drive the robotic system's operations, as described herein.

In some embodiments, the local memory comprises one or more local memory mechanisms of the PLC 404. The local memory, for example, may comprise volatile, high-speed integrated memory (e.g., hierarchical memory structure, circular buffers, flash storage) that is directly accessible by one or more processing elements of the PLC 404. In addition, or alternatively, the local memory may comprise external storage devices, such as disk-based storage, hard drives, and/or the like that may be directly connected to the one or more processing elements to reduce latency. In any case, the local memory may comprise one or more hardware and/or software components, such as memory chips (e.g., RAM chips integrated into the PLC's circuit board), memory management logic (e.g., allocation/deallocation protocols, caching strategies), and/or the like to provide high-speed memory access at the PLC 404 and enable real-time control capabilities, as required in a robotic system 408, based on data maintained at a remote server 402.

In some embodiments, the PLC 404 provides an executable instruction to a component of the robotic system 408 based on a data element of the set of data elements within a data object of the control array 610.

In some examples, the PLC 404 provides the executable instruction to the component of the robotic system 408 by selecting a data element from the control array 610 according to one or more execution criteria. The execution criteria, for example, may comprise a time-based criteria (first-in, first out (FIFO), order criteria (e.g., order priority assigned by the remote server 402), tote location (e.g., distance of preassigned tote from a loading platform), and/or the like.

In some examples, PLC 404 may select the data element based on a set of task speed predictions and determine the data entry from the sorted local table. For example, the PLC 404 may determine a set of task speed predictions that respectively corresponds to a set of data elements within a data object of the control array 610. In some examples, the data object may be determined based on a detected presence of a tote within a loading position of the robotic system 408. The task speed prediction of the set of task speed predictions may be based on (a) an orientation of at least a portion of the robotic system, and/or (b) a retrieval position of an object corresponding to a respective data element. In some examples, the robotic system 408 comprises a robotic arm 406 and a multi-channel storage platform 412, the orientation of at least the portion of the robotic system 408 may be based on orientation data from the robotic arm 406, and/or the retrieval position of the object may be based on a mapping between an object identifier within the data element and a channel of the multi-channel storage platform.

In some embodiments, the task speed prediction comprises a relative or absolute estimated completion speed for updating the dynamic elements of a data element through the performance of robotic tasks by the robotic system 408. Task speed prediction, for example, may comprise a predicted categorical and/or numerical value that represents a predicted speed of a logistical task for an object identified by a data element. In some examples, the PLC 404 may prioritize tasks based on their expected execution time to improve the overall throughput of the robotic system 408.

In some examples, the task speed prediction may be based on a current orientation of the robotic arm 406, a physical layout of the multi-channel storage platform 412, and/or a retrieval position, within the physical layout of the multi-channel storage platform 412 (e.g., a channel), of the object identified by the data element.

The orientation of the robotic arm 406, for example, may identify a physical position of the robotic arm 406 within the robotic system 408. The orientation may be represented as a set of numerical values that describe the position and/or angular configuration of the robotic arm's joints. In some examples, the orientation may comprise Cartesian coordinates (x, y, z) for the end effector's position in three-dimensional space, rotational values (e.g., roll, pitch, yaw) that define the robotic arm's articulation, quaternions or transformation matrices to capture the full range of possible configurations, and/or the like.

The retrieval position of the object may identify a channel of the multi-channel storage platform 412 where an object of a data element is located. The retrieval position may comprise Cartesian coordinates (x, y, z) of the channel, a channel identifier, a relative channel position relative to the multi-channel storage platform 412, and/or the like.

In some examples, the task speed prediction may comprise a travel distance between the orientation of the robotic arm 406 and the retrieval position of the object within a data element. In this manner, travel distance may provide a proxy for task speed, which may enable intelligent task scheduling in real time. By estimating the time required to complete each task, the PLC 404 may dynamically reorder the execution sequence of a local table 606 to minimize overall completion time and maximize throughput. This is particularly valuable in complex robotic systems where the time required for different operations may vary significantly based on factors such as travel distance, object characteristics, and current system state.

In some embodiments, the data element comprises a location within a data object that is accessed for use in executing a task assigned to the robotic system 408. The data element serves as a data structure that encapsulates a set of information for a specific task to be performed by the robotic system 408. In some examples, the data element may be implemented as a structured data type within the PLC 404 local memory. By way of example, the data element may comprise an element within a struct of the control array 610, and/or the like, depending on the programming language and/or environment used in the PLC 404. The data element may comprise both static elements, which may be provided by the remote server 402 and remain constant throughout the task execution, and dynamic elements, which may be updated as the task progresses.

The process of utilizing the data elements of the control array 610 involves several technical steps within the PLC 404. When a task is selected for execution, the corresponding data element from the control array may be read. As the robotic system 408 executes the task, the PLC 404 may update the dynamic elements of the data element based on feedback and sensor data, providing a real-time representation of the task's progress. In this manner, the data element may serve as the primary interface between the high-level task planning system and the low-level robotic control operations. The data element, for example, may provide a standardized format for task information that may be easily interpreted and acted upon by various components of the robotic system 408. By encapsulating all relevant task data in a single structure, the data element simplifies task management, reduces the likelihood of data inconsistencies, and facilitates efficient communication between different modules of the robotic control software.

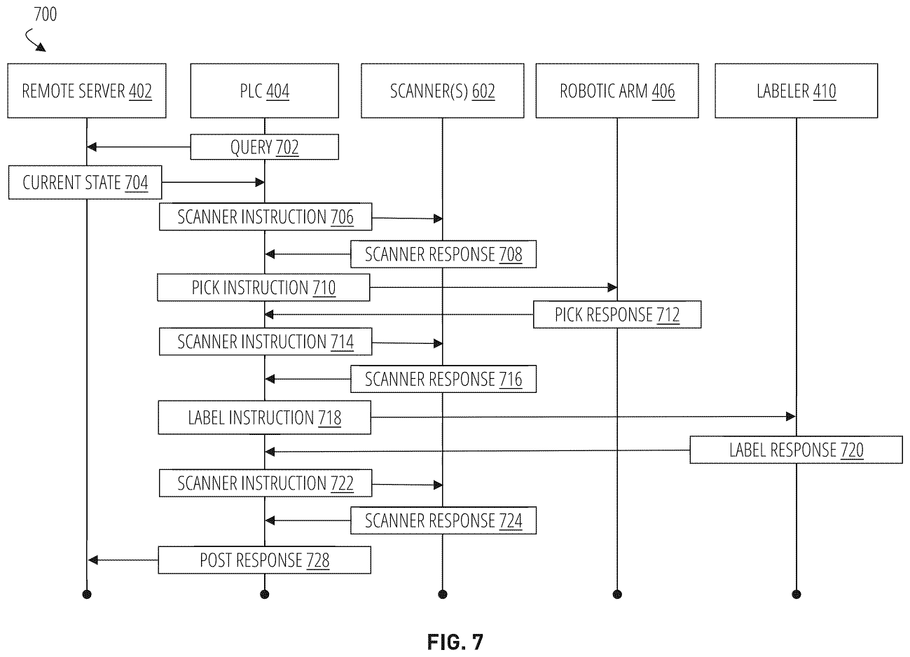

In some embodiments, the PLC 404 provides one or more executable instructions 612 to one or more components of the robotic system 408 based on the data element of the set of data elements within the data object of the control array. For example, the PLC 404 may provide one or more executable instructions 612 to the robotic arm 406, the scanner(s) 602, the labeler 410, and/or the like, as described with reference to FIG. 7.

In some embodiments, the executable instructions 612 comprise control instruction from the PLC 404 to a component of the robotic system 408 and/or to the remote server 402. An executable instruction, for example, may comprise a specific command and/or set of commands that direct the behavior of individual components within the robotic system 408 to perform a particular action or series of actions. In some examples, an executable instruction 612 may be implemented as low-level machine code, and/or microcode, which may be directly interpreted and/or executed by the hardware components of the robotic system 408.

In some examples, the executable instructions 612 may be generated by the PLC 404 based on the high-level task information contained in the control array 610. To do so, the PLC 404 may interpret a current task state of a task as represented by the control array 610 (e.g., the values of the dynamic elements therein). Based on the current task state, along with preprogrammed logic and/or real-time sensor data, the PLC 404 may determine the next robotic action. The PLC 404 may encode the next robotic action into one or more executable instructions 612 using a protocol specific to the target component (e.g., a robotic arm 406, scanner(s) 602, or a labeler 410) and transmit the executable instructions 612 to the target component (e.g., through a real-time communication bus such as EtherCAT, PROFINET)

In this way, executable instructions 612 may serve as a direct link between the high-level task planning performed by the PLC 404 and the physical actions carried out by the robotic system components. They enable precise control over various aspects of the robotic system's operation, such as the movement of the robotic arm 406, the activation of the scanner(s) 602, the printing of a label, and/or the like. By breaking down complex tasks into sequences of simple, executable instructions 612, the PLC 404 may achieve complex behaviors while maintaining fine-grained control and error handling capabilities.

In some embodiments, the PLC 404 and the remote server 402 collaborate to perform one or more tasks within the robotic system 408. By way of example, the executable instructions 612 may comprise label instructions, in which the PLC 404 may transmit a TCP message (or other message type) to the remote server 402 to print a specified prescription. The label instructions may cause the remote server 402 to transmit a print string to the labeler 410 to print an object label. Thereafter, the executable instructions 612 may comprise a scanner instruction, in which the PLC 404 may transmit a message to a label scanner to scan a label adhered to the object. The PLC 404 may receive the scanned data from the label scanner and store the data as an element within the control array 610. In this way, the PLC 404 may store data provided by the remote server 402 through a verification of a physical label printed by the remote server 402.

In some embodiments, the PLC 404 receives one or more execution responses 614 from the one or more components of the robotic system 408, such as the robotic arm 406, the scanner(s) 602, the labeler 410, and/or the like, as described with reference to FIG. 7. For example, the PLC 404 may receive from the components of the robotic system 408, the execution responses 614 based on the executable instructions 612. The PLC 404 may update one or more dynamic elements of the set of dynamic elements based on the execution responses 614.

In some embodiments, the execution responses 614 comprise control responses received by the PLC 404 responsive to executable instructions 612 that provides feedback from a component of the robotic system 408. In this manner, execution responses 614 may form a feedback loop that allows the PLC 404 to monitor and manage the operations of the robotic system 408. An execution response 614, for example, may comprise a structured data packet that is transmitted from a robotic system component back to the PLC 404 after the completion (or attempted completion) of an executable instruction 612. The execution response 614 may comprise status information, such as success or failure flags, error codes, and/or any relevant data collected during the execution of the executable instruction 612. The format and/or content of the execution response 614 may be defined by the communication protocol used between the PLC 404 and/or the specific component, such as PROFINET, EtherCAT, and/or the like.

In some embodiments, the PLC 404 updates, based on the execution responses from the components of the robotic system 408, dynamic elements of the set of dynamic elements within a data element of a data object within the control array 610. The PLC 404 may update the dynamic elements to locally monitor the progress of the robotic system 408 with respect to an object (e.g., data element level) and/or the order (e.g., data object level) within which the object belongs.

In some embodiments, the PLC 404 provides one or more query responses to the remote server 402 in response to one or more designated updates to the dynamic elements of the data elements within a data object. For example, the PLC 404 may provide a first, element-level query response to the remote server 402 in response to a detection that each of the dynamic elements is populated with a data value. In addition, or alternatively, the PLC 404 may provide a second, object-level query response to the remote server 402 in response to a detection that each of the dynamic elements within a data object (e.g., with each data element within the data object) is populated with a data value.

By way of example, responsive to determining that a data element comprises a data value for each of the set of dynamic elements, the PLC 404 may provide, to the remote server 402, a query response to initiate an update to the host table 604 based on the data value for each of the set of dynamic elements of the data element within the data object. The set of dynamic elements, for example, may comprise the label identifier (e.g., updated responsive to a labeling operation), the object identifier (e.g., updated responsive to an object scanning operation), and/or a status identifier. By way up to each of the set of dynamic elements may correspond to a robotic action of the robotic system. The label identifier, for example, may be updated in response to a labeling action, the object identifier may be updated in response to a scanning operation, and/or the status identifier may be updated in response to a placing operation. In some examples, the PLC 404 may provide the query response in response to an update to the status identifier indicating that an object is placed within a tote on a conveyance line.

In some embodiments, the element-level query response comprises a data element that is updated based on the operations of the robotic system 408. The element-level query response may represent a final state of a task after it has been processed by the robotic system 408, encapsulating the results and/or any relevant data collected during the execution of the task through the modification of the dynamic elements within the data element. By way of example, the element-level query response may be implemented as a data structure that mirrors the format of the data element, but with its dynamic elements populated and/or updated to reflect one or more outcomes of the robotic operations within the robotic system 408. The element-level query response, for example, may retain the static elements from the original data entry while updating the dynamic elements based on execution responses 614 and/or other feedback received during task execution.

In some embodiments, the PLC 404 provides a second, object-level query response in response to updating a final dynamic element of a data object within the control array 610. For example, in response to determining that the final dynamic element is within the final data element of the set of data elements, the PLC 404 may provide the object-level query response to initiate an update to the host table 604 to update the object status identifier within each of the set of data entries corresponding to the data object. By way of example, the object-level query response may comprise an update message the instructs the remote server 402 to update the object status identifier for a list of data entries respectively corresponding to the set of data elements within the data object. The object-level query response may instruct the remote server to update the object status identifier to “placed” to indicate that each of the objects associated with a particular order are placed within a tote on a conveyance line.

In some embodiments, the remote server 402 may receive the object-level query response and, in response to receiving the object-level query response, the remote server 402 may update each of the listed data entries in the object-level query response to reflect an updated object status identifier. The remote server 402 may monitor the host table 604 for updates to the object status identifier. In some examples, in response to detecting an update to the object status identifier of one or more data entries, the remove server 402 may remove the one or more data entries from the host table 604 and copy the one or more data entries to the outbound table 608. In addition, or alternatively, the remote server 402 may determine the one or more data entries associated with updated object status identifier based on a second polling interval.

n some embodiments, the second polling interval comprises an interval of time (e.g., 1000 milliseconds) designed to trigger an update to the outbound table 608 from the host table 604. The second polling interval may be a predefined, static time interval. In addition, or alternatively, the second polling interval may be dynamically set based on one or more constraints of the robotic system 408. For example, the polling interval may be set based on an execution time (e.g., average, minimum, maximum) of a task by the robotic system 408. By way of example, the polling interval may be set to a time interval (e.g., 1000 milliseconds) that is less than a minimum task duration (e.g., 2 seconds) of the robotic system 408 to ensure a synchronization between the robotic system 408 and the remote server 402. In this manner, the second polling interval may provide another synchronization parameter between the robotic system 408 and the remote server 402, that may be modified to adjust a frequency with which the robotic system 408 synchronizes an outbound table 608 with a host table 604 of the remote server 402.

FIG. 7 is a message flow diagram 700 of a localized control process for a robotic system in accordance with some embodiments of the present disclosure. A computing system, such as the PLC 404, may execute the localized control process to improve the efficiency, reliability, and adaptability of the robotic system. To do so, the localized control process enables task-level communication directly between a remote server 402 and the PLC 404. This direct communication simplifies the robotic process, reduces potential troubleshooting layers, and ensures a more stable and efficient robotic operations.

The message flow diagram 700 may comprise a set of asynchronous processes. During the first asynchronous process, the PLC 404 may provide a query 702 to the remote server 402. The remote server 402 may receive the query 702 and respond with at least a portion of a current state 704 of a host table that corresponds to the query 702. For example, as described herein, at least the portion of the current state 704 of the host table may correspond to a table identifier within the query 702 and/or one or more shared identifiers. The PLC 404 may replace a control array with at least the portion of the current state 704 of the host table to inform subsequent robotic processes within the robotic system. This process may be repeated at a first polling interval (and/or in response to stimuli, such as a detection of a tote within a proximity to the robotic system) to continuously synchronize the control array with a host table maintained at the remote server.

At a second asynchronous process, the PLC 404 may select a data element from a data object of the control array. Using the data element, the PLC 404 may issue one or more executable instructions to the remote server 402 and/or components of the robotic system 408.

For example, the PLC 404 may provide a conveyor scanner instruction 706 to a conveyor scanner positioned at a loading platform of the robotic system. The conveyor scanner instruction 706 may be configured to cause the conveyor scanner to perform a tote scanning operation for a tote positioned on a conveyance assembly. By way of example, the conveyor scanner instruction 706 may comprise a control instruction from the PLC 404 to the conveyor scanner to trigger a scanning operation for a tote located at the loading platform.

The PLC 404 may receive a conveyor scanner response 708 from the conveyor scanner based on the conveyor scanner instruction 706. The conveyor scanner response 708 may comprise an object tote identifier for a tote within a loading platform of the robotic system. In some examples, the PLC 404 may update the object tote identifier of the data element based on the conveyor scanner response 708. In addition, or alternatively, the PLC 404 may flag the control array in the event that the scanner response 708 fails to match a read-only (e.g., remote server assigned) object tote identifier.

In addition, or alternatively, the PLC 404 may provide a pick instruction 710 configured to cause the robotic arm 406 to a perform a pick operation for an object positioned at a channel of the multi-channel storage platform 412. The pick instruction 710 may comprise a control instruction from the PLC 404 to the robotic arm 406 that requests a picking operation to move an object from a channel of the multi-channel storage platform to the tote located at the loading platform.

The PLC 404 may receive a pick response 712 from the robotic arm 406 based on the pick instruction 710. The pick response 712 may comprise a success or failure message for the pick operation. For example, the pick response 712 may indicate a success or failure of a picking operation based on a sensor within and/or adjacent to an end effector of the robotic arm 406. In some examples, the PLC 404 may update the object status identifier of the data element based on the pick response 712. For example, in response to a success message, the PLC 404 may update the object status identifier to “picked”. In addition, or alternatively, in response to a failure message, the PLC 404 may flag the data element.

In some examples, the PLC 404 may provide an object scanner instruction 714 configured to cause the object scanner to a perform a barcode scanning operation for an object picked by the robotic arm 406. The object scanner instruction 714 may be configured to cause the object scanner to perform an object scanning operation for an object held by an end effector of the robotic arm 406. By way of example, the object scanner instruction 714 may comprise a control instruction from the PLC 404 to the object scanner to trigger a scanning operation for a held object.

The PLC 404 may receive an object scanner response 716 from the object scanner based on the object scanner instruction 714. The object scanner response 716 may comprise an object identifier for an object. In some examples, the PLC 404 may update the object identifier (e.g., GS1 barcode) of the data element based on the object scanner response 716. In addition, or alternatively, the PLC 404 may flag the data element in the event that at least a portion of the object scanner response 716 fails to match a read-only (e.g., remote server assigned) object type identifier, origination identifier, and/or the like. By way of example, the PLC 404 may parse out the object type identifier and/or origination identifier from the object identifier to compare the extracted object type identifier and/or origination identifier of the scanned object identifier to the object type identifier and/or origination identifier of the data element. In some examples, in response to the object type identifier and/or origination identifier matching the object type identifier and/or origination identifier of the data element, the PLC 404 may update the object status identifier of the data element to “verified”. The entire scanned object identifier may then be written to the data element as a new data value.

In some examples, the PLC 404 may provide a first label instruction to the remote server 402 that comprises the object identifier. In response to receiving the object identifier, the remote server 402 may provide a label instruction 718 to the labeler 410. The label instruction 718 may be configured to cause the labeler 410 to a perform a labeling operation for an object picked by the robotic arm 406. In some examples, the label instruction 718 may comprise a set of order details associated with the object and/or a label identifier. In some examples, the labeler 410 may perform the label operation and respond with a label response 720 to the remote server 402. The label response may identify a success and/or failure of a labeling operation. The remote server 402 may receive the label response 720 and provide an indication of the label response 720 to the PLC 404. In some examples, in response to receiving an indication of a successful labeling operation, the PLC 404 may update the object status identifier of the data element to “labeled”.

In some examples, the PLC 404 may provide a label scanner instruction 722 to a label scanner. The label scanner instruction 722 may be configured to cause the label scanner to a perform a scanning operation for a label applied to the object picked by the robotic arm 406. The PLC 404 may receive a label scanner response 724 from the label scanner based on the label scanner instruction 722. The label scanner response 724 may comprise a label identifier for a label adhered to the object. In some examples, the PLC 404 may update the label identifier of the data element based on the label scanner response 724. In some examples, in response to receiving the label scanner response 724 the PLC 404 may update the object status identifier of the data element to “label verified”. In some examples, the PLC 404 may update the object identifier within the data element to the label identifier to track a labeled instance of the object.

In some examples, the PLC 404 may receive placing response from the robotic arm 406. In response to the placing response, the PLC 404 may update the object status identifier of the data element to “placed”. In addition, or alternatively, the PLC 404 may post a response to the remote server 402 to initiate an update to the host table.

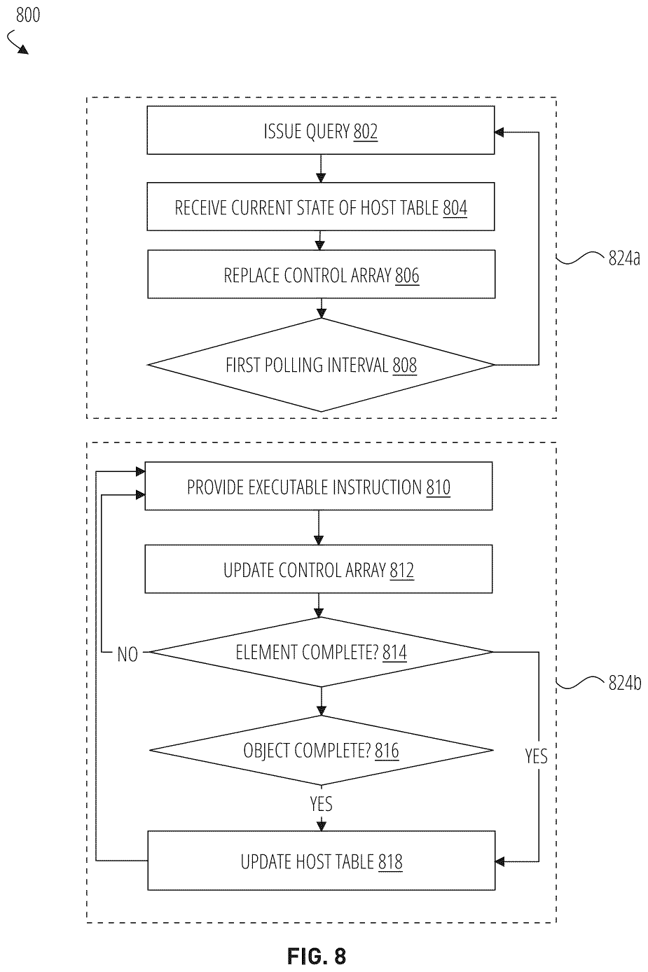

FIG. 8 is a flowchart diagram of an example localized control process 800 in accordance with some embodiments of the present disclosure. The flowchart diagram depicts a robotic control technique that moves control of a robotic system from a remote server to programmable logic controller (PLC) of the robotic system. The process 800 may be implemented by one or more computing devices, entities, and/or systems described herein. For example, via the various steps/operations of the process 800, the PLC 404 may implement a set of asynchronous operations to synchronize the robotic operations of a robotic system with a current state of a remote server. By doing so, the process 800 improves the efficiency, reliability, and adaptability of the robotic system by allowing task-level communication directly between a remote server and the PLC 404. This direct communication simplifies the robotic process, reduces potential troubleshooting layers, and ensures a more stable and efficient robotic operations.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 is implemented as one or more asynchronous processes 820A-B. At a first asynchronous process 820A, the PLC 404 may issue queries to a remote server to synchronize a control array with a current state of a host table managed by the remote server. At a second asynchronous process 820B, the PLC 404 may communicate with various components of the robotic system to execute and record a logistical task and update the host table based on the execution of the logistical tasks.

In some embodiments, the process 800 comprises, at operation 802, issuing a query to a remote server. For example, the PLC 404, during the first asynchronous process 820A, may provide, to the remote server, the query at the first a first polling interval. In some examples, the remote server 402 may store a set of host tables that respectively corresponds to a set of robotic systems within a logistics facility. The query may comprise a unique table identifier corresponding to the robotic system.

In some embodiments, the process 800 comprises, at operation 804, receiving a current state of a host table. For example, the PLC 404, during the first asynchronous process 820A, may provide the query at a first polling interval. At least the portion of the current state of the host table may be received in response to a query to the remote server with the table identifier that corresponds to the robotic system. For example, the PLC 404 may receive, and from a remote server 402, at least the portion of the current state of a host table 604. The host table, for example, may correspond to a table identifier associated with a robotic system and/or one or more shared identifiers.

In some embodiments, the process 800 comprises, at operation 806, replacing a control array at the PLC 404. For example, the PLC 404, during the first asynchronous process 820A, may store at least the portion of the current state of the host table within a local memory as a control array for instructing the robotic system based on a data entry from the host table. The control array, for example, may comprise an array of data objects and a data object of the array of data objects may comprise a set of data elements respectively corresponding to a set of data entries from the host table that comprise the data entry and one or more related data entries associated with a shared identifier. In some examples, the PLC may store at least the portion of the current state of the host table within the local memory as the control array by removing a preexisting control array and regenerating the control array based on at least the portion of the current state of the host table.

In some examples, the PLC 404 may receive the data entry from the host table, determine the shared identifier within the data entry, and store the data entry as the data element within the data object based on the shared identifier. The data element, for example, may comprise a set of static elements received from the remote server and/or the set of dynamic elements. Each of the set of dynamic elements may correspond to a robotic action of the robotic system.

In some embodiments, the process 800 comprises, at operation 808, determining an expiration of a first polling interval. For example, the PLC 404, during the first asynchronous process 820A, may determine whether a first polling interval corresponding to the first asynchronous process 820A has expired. If the first polling interval has expired, the PLC 404 may return to operation 802 to issue another query to the remote server. In addition, or alternatively, the PLC 404 may issue the query in response to an external stimuli, such as a detection of a tote within a proximity to the robotic system.

In some embodiments, the process 800 comprises, at operation 810, providing an executable instruction to a component of robotic system. For example, the PLC 404, during the second asynchronous process 820B, may provide an executable instruction to a component of the robotic system based on a data element of the set of data elements within the data object of the control array.

In some embodiments, the process 800 comprises, at operation 812, updating a control array. For example, the PLC 404, during the second asynchronous process 820B, may store a data element for instructing the robotic system based on a data entry from the local table. The data element, for example, may comprise a set of static elements received from the remote server 402 and/or a set of dynamic elements that may be modifiable by the PLC 404. In some examples, the PLC 404 may receive one or more execution responses from the one or more components of the robotic system. For example, the PLC 404 may receive, from the components of the robotic system, the execution responses based on the executable instructions. The PLC 404 may update, based on an execution response from the component of the robotic system, a dynamic element of a set of dynamic elements within the data element.

In some examples, the PLC 404 may determine a set of task speed predictions that respectively corresponds to a set of data elements within the data object. The task speed prediction of the set of task speed predictions may be based on (a) an orientation of at least a portion of the robotic system, and/or (b) a retrieval position of an object corresponding to a respective data element. The PLC 404 may determine the data element from the data object based on the set of task speed predictions. In some examples, the robotic system comprises a robotic arm and/or a multi-channel storage platform. The orientation of at least the portion of the robotic system may be based on orientation data from the robotic arm, and the retrieval position of the object may be based on a mapping between an object identifier within the data element and a channel of the multi-channel storage platform.

By way of example, the robotic system may comprise a conveyor scanner, an object scanner, a labeler, and a label scanner, and/or the like. The executable instructions may comprise a set of executable instructions that comprise at least one of: a conveyor scanner instruction configured to cause the conveyor scanner to perform a tote scanning operation for a tote positioned on a conveyance assembly; a pick instruction configured to cause the robotic arm to a perform a pick operation for an object positioned on the channel of the multi-channel storage platform; an object scanner instruction configured to cause the object scanner to a first perform a barcode scanning operation for an object picked by the robotic arm; a label instruction configured to cause the labeler to a perform a labeling operation for the object picked by the robotic arm; and a label scanner instruction configured to cause the label scanner to a perform a second barcode scanning operation for a label applied to the object picked by the robotic arm.

In some embodiments, the process 800 comprises, at operation 814, determining whether a data element is complete. For example, responsive to determining that the data element comprises a data value for each of the set of dynamic elements, the PLC 404 may provide, to the remote server, an element-level query response to initiate an update to the host table based on the data value for each of the defined subset of the set of dynamic elements. Otherwise, the process 800 may return to operation 810 to perform another executable instruction.

In some embodiments, the process 800 comprises, at operation 816, determining whether a data element is complete. For example, responsive to determining that the data element comprises a data value for each of the set of dynamic elements, the PLC 404 may provide, to the remote server, an element-level query response to initiate an update to the host table based on the data value for each of the defined subset of the set of dynamic elements. Otherwise, the process 800 may return to operation 810 to perform another executable instruction.

In some embodiments, the process 800 comprises, at operation 818, updating the host table of the remote server. For example, the PLC 404 may provide, to the remote server, an element-level query response and/or an object-level query response to initiate an update to the host table. For example, the PLC 404 may provide an element-level query response in response to updating a final dynamic element of the set of dynamic elements within a data element. In addition, or alternatively, the final dynamic element may be within a final data element of the set of data elements, and the PLC 404 may, in response to determining that the final dynamic element is within the final data element of the set of data elements, provide, to the remote server, an object-level query response to initiate another update to the host table to update an object status identifier within each of the set of data entries respectively corresponding to the set of data elements. In some examples, the remote server may be configured to remove the set of data entries from the host table and copy the set of data entries to an outgoing table in response to a detection of the update to the object status identifier within each of the set of data entries respectively corresponding to the set of data elements.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors and from a remote server, at least a portion of a current state of a host table, wherein the host table corresponds to a table identifier associated with a robotic system; storing, by the one or more processors, at least the portion of the current state of the host table within a local memory as a control array for instructing the robotic system based on a data entry from the host table, wherein the control array comprises an array of data objects and a data object of the array of data objects comprises a set of data elements respectively corresponding to a set of data entries from the host table that comprise the data entry and one or more related data entries associated with a shared identifier; providing, by the one or more processors, an executable instruction to a component of the robotic system based on a data element of the set of data elements within the data object of the control array; updating, by the one or more processors and based on an execution response from the component of the robotic system, a dynamic element of a set of dynamic elements within the data element; responsive to determining that the data element comprises a data value for each of the set of dynamic elements, providing, by the one or more processors and to the remote server, an element-level query response to initiate an update to the host table based on the data value for each of the defined subset of the set of dynamic elements.

Example 2. The computer-implemented method of claim 1, wherein the computer-implemented method is performed by a programmable logic controller of the robotic system.

Example 3. The computer-implemented method of claim 1, wherein generating the control array comprises receiving the data entry from the host table; determining the shared identifier within the data entry; and storing the data entry as the data element within the data object based on the shared identifier.

Example 4. The computer-implemented method of claim 3, wherein the data element comprises a set of static elements received from the remote server and the set of dynamic elements, each of the set of dynamic elements corresponds to a robotic action of the robotic system.

Example 5. The computer-implemented method of claim 4, further comprising providing the element-level query response in response to updating a final dynamic element of the set of dynamic elements.

Example 6. The computer-implemented method of claim 5, wherein the final dynamic element is within a final data element of the set of data elements, and the computer-implemented method further comprises in response to determining that the final dynamic element is within the final data element of the set of data elements, providing, to the remote server, an object-level query response to initiate another update to the host table to update an object status identifier within each of the set of data entries respectively corresponding to the set of data elements.

Example 7. The computer-implemented method of claim 6, wherein the remote server is configured to remove the set of data entries from the host table and copy the set of data entries to an outgoing table in response to a detection of the update to the object status identifier within each of the set of data entries respectively corresponding to the set of data elements.

Example 8. The computer-implemented method of claim 1, wherein at least the portion of the current state of the host table is received in response to a query to the remote server comprising at least one of the table identifier that corresponds to the robotic system or one or more shared identifiers.

Example 9. The computer-implemented method of claim 7, wherein the remote server stores a set of host tables that respectively corresponds to a set of robotic systems within a logistics facility, and the table identifier is unique to the robotic system of the set of robotic systems.

Example 10. The computer-implemented method of claim 1, wherein providing the executable instruction to the component of the robotic system based on the data object of the control array comprises determining a set of task speed predictions that respectively corresponds to a set of data elements within the data object, wherein a task speed prediction of the set of task speed predictions is based on (a) an orientation of at least a portion of the robotic system, and (b) a retrieval position of an object corresponding to a respective data element; determining the data element from the data object based on the set of task speed predictions.

Example 11. The computer-implemented method of claim 10, wherein the robotic system comprises a robotic arm and a multi-channel storage platform, the orientation of at least the portion of the robotic system is based on orientation data from the robotic arm, and the retrieval position of the object is based on a mapping between an object identifier within the data element and a channel of the multi-channel storage platform.

Example 12. The computer-implemented method of claim 11, wherein the robotic system further comprises a conveyor scanner, an object scanner, a labeler, and a label scanner, and the executable instruction is one of a set of executable instructions that comprise at least one of a conveyor scanner instruction configured to cause the conveyor scanner to perform a tote scanning operation for a tote positioned on a conveyance assembly; a pick instruction configured to cause the robotic arm to a perform a pick operation for an object positioned on the channel of the multi-channel storage platform; an object scanner instruction configured to cause the object scanner to a first perform a barcode scanning operation for the object picked by the robotic arm; a label instruction configured to cause the labeler to a perform a labeling operation for the object picked by the robotic arm; and a label scanner instruction configured to cause the label scanner to a perform a second barcode scanning operation for a label applied to the object picked by the robotic arm.

Example 13. The computer-implemented method of claim 1, wherein storing at least the portion of the current state of the host table within the local memory as the control array comprises removing a preexisting control array and regenerating the control array based on at least the portion of the current state of the host table.

Example 14. A system comprising one or more processors; and one or more memories storing processor-executable instructions that, when executed by the one or more processors, cause the one or more processors to perform operations comprising receiving, from a remote server, at least a portion of a current state of a host table, wherein the host table corresponds to a table identifier associated with a robotic system; storing at least the portion of the current state of the host table within a local memory as a control array for instructing the robotic system based on a data entry from the host table, wherein the control array comprises an array of data objects and a data object of the array of data objects comprises a set of data elements respectively corresponding to a set of data entries from the host table that comprise the data entry and one or more related data entries associated with a shared identifier; providing an executable instruction to a component of the robotic system based on a data element of the set of data elements within the data object of the control array; updating, based on an execution response from the component of the robotic system, a dynamic element of a set of dynamic elements within the data element; responsive to determining that the data element comprises a data value for each of the set of dynamic elements, providing, to the remote server, an element-level query response to initiate an update to the host table based on the data value for each of the defined subset of the set of dynamic elements.

Example 15. The system of claim 13, wherein the system is a programmable logic controller of the robotic system.

Example 16. The system of claim 13, wherein generating the control array comprises receiving the data entry from the host table; determining the shared identifier within the data entry; and storing the data entry as the data element within the data object based on the shared identifier.

Example 17. The system of claim 16, wherein the data element comprises a set of static elements received from the remote server and the set of dynamic elements, each of the set of dynamic elements corresponds to a robotic action of the robotic system.

Example 18. The system of claim 16, wherein the operations further comprise providing the element-level query response in response to updating a final dynamic element of the set of dynamic elements.

Example 19. One or more non-transitory computer-readable media storing processor-executable instructions that, when executed by one or more processors, cause the one or more processors to perform operations comprising receiving, from a remote server, at least a portion of a current state of a host table, wherein the host table corresponds to a table identifier associated with a robotic system; storing at least the portion of the current state of the host table within a local memory as a control array for instructing the robotic system based on a data entry from the host table, wherein the control array comprises an array of data objects and a data object of the array of data objects comprises a set of data elements respectively corresponding to a set of data entries from the host table that comprise the data entry and one or more related data entries associated with a shared identifier; providing an executable instruction to a component of the robotic system based on a data element of the set of data elements within the data object of the control array; updating, based on an execution response from the component of the robotic system, a dynamic element of a set of dynamic elements within the data element; responsive to determining that the data element comprises a data value for each of the set of dynamic elements, providing, to the remote server, an element-level query response to initiate an update to the host table based on the data value for each of the defined subset of the set of dynamic elements.

Example 20. The one or more non-transitory computer-readable media of claim 18, wherein at least the portion of the current state of the host table is received in response to a query to the remote server comprising at least one of the table identifier that corresponds to the robotic system or one or more shared identifiers.

What is claimed is:

1. A computer-implemented method comprising:
receiving, by one or more processors and from a remote server, at least a portion of a current state of a host table, wherein the host table corresponds to a table identifier associated with a robotic system;
storing, by the one or more processors, at least the portion of the current state of the host table within a local memory as a control array for instructing the robotic system based on a data entry from the host table, wherein the control array comprises an array of data objects and a data object of the array of data objects comprises a set of data elements respectively corresponding to a set of data entries from the host table that comprise the data entry and one or more related data entries associated with a shared identifier;
providing, by the one or more processors, an executable instruction to a component of the robotic system based on a data element of the set of data elements within the data object of the control array;
updating, by the one or more processors and based on an execution response from the component of the robotic system, a dynamic element of a set of dynamic elements within the data element;
responsive to determining that the data element comprises a data value for each of the set of dynamic elements, providing, by the one or more processors and to the remote server, an element-level query response to initiate an update to the host table based on the data value for each of the defined subset of the set of dynamic elements.

2. The computer-implemented method of claim 1, wherein the computer-implemented method is performed by a programmable logic controller of the robotic system.

3. The computer-implemented method of claim 1, wherein generating the control array comprises:
receiving the data entry from the host table;
determining the shared identifier within the data entry; and
storing the data entry as the data element within the data object based on the shared identifier.

4. The computer-implemented method of claim 3, wherein the data element comprises a set of static elements received from the remote server and the set of dynamic elements, each of the set of dynamic elements corresponds to a robotic action of the robotic system.

5. The computer-implemented method of claim 4, further comprising providing the element-level query response in response to updating a final dynamic element of the set of dynamic elements.

6. The computer-implemented method of claim 5, wherein the final dynamic element is within a final data element of the set of data elements, and the computer-implemented method further comprises:
in response to determining that the final dynamic element is within the final data element of the set of data elements, providing, to the remote server, an object-level query response to initiate another update to the host table to update an object status identifier within each of the set of data entries respectively corresponding to the set of data elements.

7. The computer-implemented method of claim 6, wherein the remote server is configured to remove the set of data entries from the host table and copy the set of data entries to an outgoing table in response to a detection of the update to the object status identifier within each of the set of data entries respectively corresponding to the set of data elements.

8. The computer-implemented method of claim 1, wherein at least the portion of the current state of the host table is received in response to a query to the remote server comprising at least one of the table identifier that corresponds to the robotic system or one or more shared identifiers.

9. The computer-implemented method of claim 7, wherein the remote server stores a set of host tables that respectively corresponds to a set of robotic systems within a logistics facility, and the table identifier is unique to the robotic system of the set of robotic systems.

10. The computer-implemented method of claim 1, wherein providing the executable instruction to the component of the robotic system based on the data object of the control array comprises:
determining a set of task speed predictions that respectively corresponds to a set of data elements within the data object, wherein a task speed prediction of the set of task speed predictions is based on:
(a) an orientation of at least a portion of the robotic system, and
(b) a retrieval position of an object corresponding to a respective data element;
determining the data element from the data object based on the set of task speed predictions.

11. The computer-implemented method of claim 10, wherein the robotic system comprises a robotic arm and a multi-channel storage platform, the orientation of at least the portion of the robotic system is based on orientation data from the robotic arm, and the retrieval position of the object is based on a mapping between an object identifier within the data element and a channel of the multi-channel storage platform.

12. The computer-implemented method of claim 11, wherein the robotic system further comprises a conveyor scanner, an object scanner, a labeler, and a label scanner, and the executable instruction is one of a set of executable instructions that comprise at least one of:
a conveyor scanner instruction configured to cause the conveyor scanner to perform a tote scanning operation for a tote positioned on a conveyance assembly;
a pick instruction configured to cause the robotic arm to a perform a pick operation for an object positioned on the channel of the multi-channel storage platform;
an object scanner instruction configured to cause the object scanner to a first perform a barcode scanning operation for the object picked by the robotic arm;
a label instruction configured to cause the labeler to a perform a labeling operation for the object picked by the robotic arm; and
a label scanner instruction configured to cause the label scanner to a perform a second barcode scanning operation for a label applied to the object picked by the robotic arm.

13. The computer-implemented method of claim 1, wherein storing at least the portion of the current state of the host table within the local memory as the control array comprises removing a preexisting control array and regenerating the control array based on at least the portion of the current state of the host table.

14. A system comprising:
one or more processors; and
one or more memories storing processor-executable instructions that, when executed by the one or more processors, cause the one or more processors to perform operations comprising:
receiving, from a remote server, at least a portion of a current state of a host table, wherein the host table corresponds to a table identifier associated with a robotic system;
storing at least the portion of the current state of the host table within a local memory as a control array for instructing the robotic system based on a data entry from the host table, wherein the control array comprises an array of data objects and a data object of the array of data objects comprises a set of data elements respectively corresponding to a set of data entries from the host table that comprise the data entry and one or more related data entries associated with a shared identifier;
providing an executable instruction to a component of the robotic system based on a data element of the set of data elements within the data object of the control array;
updating, based on an execution response from the component of the robotic system, a dynamic element of a set of dynamic elements within the data element;
responsive to determining that the data element comprises a data value for each of the set of dynamic elements, providing, to the remote server, an element-level query response to initiate an update to the host table based on the data value for each of the defined subset of the set of dynamic elements.

15. The system of claim 13, wherein the system is a programmable logic controller of the robotic system.

16. The system of claim 13, wherein generating the control array comprises:
receiving the data entry from the host table;
determining the shared identifier within the data entry; and
storing the data entry as the data element within the data object based on the shared identifier.

17. The system of claim 16, wherein the data element comprises a set of static elements received from the remote server and the set of dynamic elements, each of the set of dynamic elements corresponds to a robotic action of the robotic system.

18. The system of claim 16, wherein the operations further comprise providing the element-level query response in response to updating a final dynamic element of the set of dynamic elements.

19. One or more non-transitory computer-readable media storing processor-executable instructions that, when executed by one or more processors, cause the one or more processors to perform operations comprising:
receiving, from a remote server, at least a portion of a current state of a host table, wherein the host table corresponds to a table identifier associated with a robotic system;
storing at least the portion of the current state of the host table within a local memory as a control array for instructing the robotic system based on a data entry from the host table, wherein the control array comprises an array of data objects and a data object of the array of data objects comprises a set of data elements respectively corresponding to a set of data entries from the host table that comprise the data entry and one or more related data entries associated with a shared identifier;
providing an executable instruction to a component of the robotic system based on a data element of the set of data elements within the data object of the control array;
updating, based on an execution response from the component of the robotic system, a dynamic element of a set of dynamic elements within the data element;
responsive to determining that the data element comprises a data value for each of the set of dynamic elements, providing, to the remote server, an element-level query response to initiate an update to the host table based on the data value for each of the defined subset of the set of dynamic elements.

20. The one or more non-transitory computer-readable media of claim 18, wherein at least the portion of the current state of the host table is received in response to a query to the remote server comprising at least one of the table identifier that corresponds to the robotic system or one or more shared identifiers.
